(19) United States
(12) Patent Application Publication
(10) Pub. No.: US 2024/0375104 A1
(43) Pub. Date: Nov. 14, 2024

(54) ACOUSTIC TRAPPING MICROCHANNEL RESONANCE DETECTION AND CONTROL

(71) Applicants: Nathan SWAMI, Charlottesville, VA (US); James P. LANDERS, Charlottesville, VA (US); Vahid FARMEHINI, Charlottesville, VA (US); Sadie Marie KIENDZIOR, Charlottesville, VA (US); UNIVERSITY OF VIRGINIA, Charlottesville, VA (US); University Of Virginia Patent Foundation, Charlottesville, VA (US)

(72) Inventors: Nathan Swami, Charlottesville, VA (US); James P. Landers, Charlottesville, VA (US); Vahid Farmehini, Charlottesville, VA (US); Sadie Marie Kiendzior, Charlottesville, VA (US)

(21) Appl. No.: 18/691,779

(22) PCT Filed: Sep. 13, 2022
(86) PCT No.: PCT/US2022/076372

§ 371 Date: Mar. 13, 2024

Related U.S. Application Data
(60) Provisional application No. 63/261,133, filed on Sep. 13, 2021.

(51) Int. Cl. B01L 3/00; B06B 1/06

(52) U.S. Cl. CPC B01L 3/502761; B06B 1/0644; B01L 2200/0668; B01L 2300/047; B01L 2400/0439; B06B 2201/55

(57) ABSTRACT

A circuit implementation for on-chip real-time resonance frequency measurement and feedback control may be used to provide improved selective particle trapping. The circuit may be based on monitoring current drawn from the amplifier used to stimulate the piezo transducer, as the high impedance measurement sensitivity in this mode does not lower the power available for stimulation of the piezo transducer. The enhanced level of control of acoustic trapping using this current mode may be used for various localized channel perturbations, including drift, wash steps and buffer swaps, as well as for selective sperm cell trapping from a heterogeneous sample that includes lysed epithelial cells.

### PRIORITY APPLICATION

This application claims priority to U.S. Provisional Application Ser. No. 63/261,133, filed Sep. 13, 2021, the disclosure of which is incorporated herein in its entirety by reference.

### STATEMENT REGARDING FEDERALLY SPONSORED RESEARCH OR DEVELOPMENT

This invention was made with government support under grant number FA2386-18-1-4100 awarded by Air Force Office of Scientific Research, and under grant number 2019-NE-BX-0004 awarded by the Department of Justice. The government has certain rights in the invention.

### BACKGROUND

Microfluidic devices including microfluidic chips are used to manipulate small volumes of fluid including cells, such as for sampling or testing of the fluids of the chip. The fluids may be manipulated in many ways, such as using centrifugal forces or by using acoustic waves. Bulk acoustic waves may be used for selective particle trapping within sample preparation, cell micropatterning, delivery for 3D printing, nanomaterial synthesis, and cell phenotypic elucidation.

### BRIEF DESCRIPTION OF THE DRAWINGS

FIG. 1 is a diagram of a microfluidic channel platform, according to an example.

FIG. 2 is a diagram of a current and voltage waveforms, according to an example.

FIG. 3 is a block diagram of an acoustic trapping system, according to an example.

FIG. 4 is a circuit diagram of an acoustic trapping system, according to an example.

FIG. 5 is a diagram of a tracking and control sequence, according to an example.

FIG. 6 is a diagram of a microfluidic device, according to an example.

FIG. 7 is a circuit diagram of a first peak detector, according to an example.

FIG. 8 is a circuit diagram of a second peak detector, according to an example.

FIG. 9 is a diagram of a non-ideal amplifier circuit, according to an example.

FIG. 10 is a diagram of an alternating current (AC) measurement circuit, according to an example.

FIG. 11 is a diagram of a multi-channel acousto-fluidic chip, according to an example.

FIG. 12 is a block diagram of an acoustic trapping array, according to an example.

FIG. 13 is a resonance frequency tracking flowchart, according to an example.

FIG. 14 illustrates an example of a block diagram of a machine upon which any one or more of the techniques discussed herein may perform according to an example.

### DETAILED DESCRIPTION

Bulk acoustic waves from a piezoelectric transducer may be used to provide particle movement and selective particle trapping (e.g., acoustophoresis), such as for sample preparation, cell micropatterning, delivery for 3D printing, nanomaterial synthesis, or cell phenotypic elucidation. This use of bulk acoustic waves for transport and trapping of a variety of particle samples may be based on active measurement and maintenance of the acoustic wave to match the microchannel resonance frequency, where the resonance frequency may be affected by device geometry, drift during trapping, and local variations in sample flow or media conditions. This may be addressed by detecting the resonance condition based on the impedance minimum and using real-time feedback to control the stimulation frequency. Impedance detection by monitoring amplitude of the stimulation voltage across the piezo transducer may include application of an overlap in frequency bandwidth of the detection and the stimulation system, which may be limited by decline in acoustic trapping power when the stimulation and resonance frequency measurement are conducted simultaneously.

A circuit implementation for on-chip real-time resonance frequency measurement and feedback control may be used to provide improved selective particle trapping. The circuit may be based on monitoring current drawn from the amplifier used to stimulate the piezo transducer, as the high impedance measurement sensitivity in this mode does not reduce the power available for stimulation of the piezo transducer. The enhanced level of control of acoustic trapping using this current mode may be used for various localized channel perturbations, including drift, wash steps and buffer swaps, as well as for selective sperm cell trapping from a heterogeneous sample that includes lysed epithelial cells.

The above discussion is intended to provide an overview of subject matter of the present patent application. It is not intended to provide an exclusive or exhaustive explanation of the invention. The description below is included to provide further information about the present patent application. In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

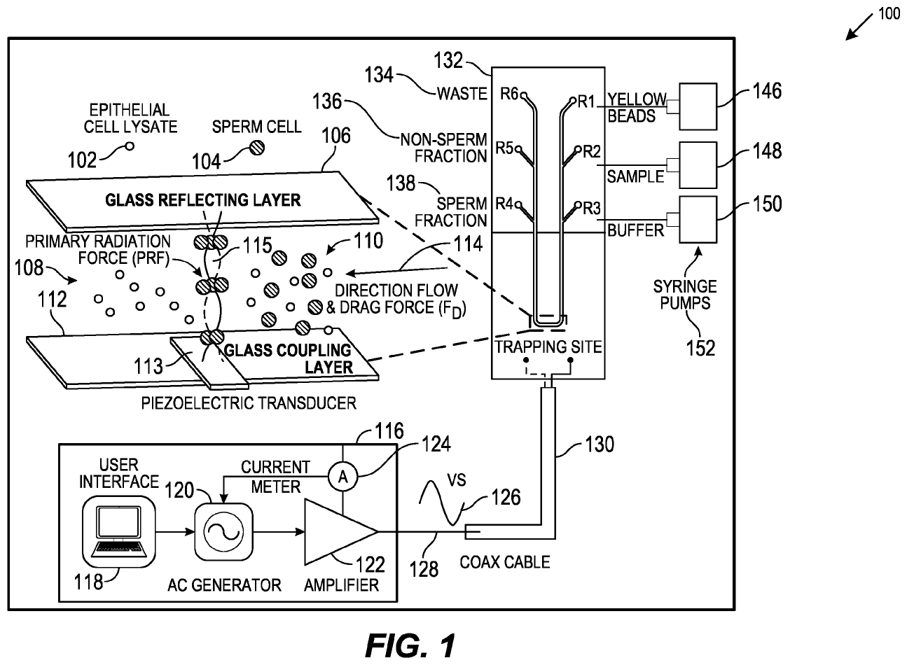

FIG. 1 is a diagram of a microfluidic channel platform 100, according to an example. The microfluidic channel platform 100 may be used to provide selective trapping and deflection (e.g., movement) of particles under acoustic force fields in a microfluidic channel, which may be used for non-destructive and non-contact manipulation of cells in biological samples. Acoustic-based particle trapping may be achieved by selective particle transport to the acoustic standing wave node or antinode, and may be used to trap a variety of particle types, including vesicles, proteins, bacteria, circulating tumour cells, and cell aggregates. To provide selective trapping and deflection of particles under acoustic force fields in a microfluidic channel, the microfluidic channel platform 100 may include a glass coupling layer 112 (e.g., standing wave node) and a glass reflecting layer 106 (e.g., antinode), which may be used for particle flow and trapping in the presence of an acoustic standing wave field. The acoustic-based particle trapping may leverage the acoustic contrast between the particle versus and the medium, as determined by the mass density, compressibility, and size of particles. By providing improved particle separation from heterogeneous samples, this acoustic-based particle trapping may be used to provide improved sample preparation, cell micropatterning, 3D printing, nanomaterial synthesis, and cell phenotypic elucidation.

In operation, piezoelectric transducer 113 may be used to generate a primary radiation force 115 (e.g., standing wave) to receive a flow of combined particles 110 and separate that flow into trapped (e.g., spatially localized) sperm cells 104 (e.g., at low pressure nodes) and non-trapped smaller debris particles 108 (e.g., epithelial cell lysate 102) under the drag force. The ability of the piezoelectric transducer 113 to trap particles may be improved by providing precise and stable acoustic trapping, which may be affected by the high sensitivity of the resonance frequency to tolerances in microchannel geometry, environmental variations (e.g., media conditions, Joule heating), and drift arising from variations in the system load during trapping. Additionally, many biological sample preparation workflows require wash steps and buffer switches, which will also alter the resonance frequency for particle trapping. The acoustic-based particle trapping described herein provides improved real-time detection of the resonance frequency, such as by using feedback to actively modulate the trapping conditions in response to these variations.

The initial resonance frequency of the microchannel may be set by selecting its width to support a half-integer multiple of the wavelength of the sound wave. Following initial resonance frequency determination and implementation, variations in actuator mounting and its coupling to the microchannel may result in variations in the resonance frequency, which may be experimentally determined for each device geometry under relevant voltage and buffer conditions. This experimental determination may be accomplished via particle image velocimetry, temperature and media control, interferometry, or suspended microprobes. Following this experimental determination, automated tuning may be used to detect and update the resonance frequency, which may vary over time due to evolving environmental conditions (e.g., temperature drift). Because the electrical impedance of the system reaches its minimum at the resonance condition, electrical impedance measurements may be applied to accurately determine and control the resonance frequency. However, despite a correlation between the electrical admittance and the resonance frequency in water-filled layered resonator devices, resonance arising from the bulk may overwhelm the resonance arising from microchannel resonance. Using a variety of theoretical simulations to decouple the channel related resonances, impedance-based methods may be used to identify an improved or optimized trapping frequency. In an example, differential impedance analysis using distilled water and 20% cesium chloride (CsCl) perfused in the microchannel may be used to determine the peak related to the microchannel resonance frequency, such as by using the metric of the absolute value of the complex impedance difference that is normalized to the absolute value of the impedance spectrum of the water filled channel. This metric may be applied to identify the initial resonance frequency, and additional steps may be used to actively monitor and control the resonance frequency over time.

The glass reflecting layer 106 and glass coupling layer 112 may be included within a microfluidic chip 132. The microfluidic chip 132 may include syringe pumps 152 at each reservoir for trapping at the indicated site, such as a buffer site 150, a sample site 148, and a yellow beads site 146. The microfluidic chip 132 may be used to separate particles into a sperm fraction 138, a non-sperm fraction 136, and waste 134.

The microfluidic chip 132 may receive an input signal from signal generation circuitry 116. The input signal may be used to provide current-based monitoring and maintenance of the resonance frequency used to generate the primary radiation force 115. The signal generation circuitry 116 may further include a user interface 118, an AC generator 120, and amplifier 122, and a current source 124. The signal generation circuitry 116 may be used to validate the maintenance of acoustic trapping over an extended time, such as using high sensitivity resonance frequency measurement during wash and buffer switch steps as described herein. The signal provided by signal generation circuitry 116 may be used by the piezoelectric transducer 113 within the microfluidic chip 132 to selectively trap sperm cells 104 heterogenous sample of combined particles 110. In an example, the isolated sperm cells 104 may be used to provide improved DNA quantification, such as via quantitative polymerase chain reaction (qPCR) to amplify male DNA.

The signal generation circuitry 116 may include a peak detector circuit. The peak detector circuit may be used to continuously monitor variations in amplitude of the stimulation voltage across the piezoelectric transducer 113, and the resonance frequency may be detected by comparing the piezo impedance at resonance to the non-zero output resistance of this circuit (resistance: R₀=50Ω). On-chip real-time resonance frequency tracking may be used to detect and dynamically control for drift, flow, or buffer swaps in the microchannel.

Voltage-based approaches may be used to detect the microchannel resonance frequency under relevant sample conditions and decouple this from extraneous resonances. The resonance detection within signal generation circuitry 116 may be selected to overlap in frequency bandwidth with the stimulation system provided to the piezoelectric transducer 113, and may be selected to reduce or eliminate any decline in acoustic trapping power when the stimulation and resonance frequency measurement are conducted simultaneously, such as to provide improved real-time control of acoustic trapping. Since most piezoelectric transducers operate over a wide range (1-10 MHZ), the implementation of a wideband peak detector for operation over the ˜MHz range may be challenging because peak detector performance degrades at higher frequencies, especially when larger input amplitudes are used for strong trapping. A wideband voltage divider may be added at the input to scale down the signal and improve the accuracy of measurement. However, such a wideband voltage divider may degrade the ability to detect the minimum voltage, since the classic peak detector error is relatively high (e.g., ˜0.3V to 0.4V) and varies with input amplitude. A circuit for peak detection may include a fast comparator IC and charger current booster, which would provide an output error that is sufficiently low (<˜40 mV) over a wide range of frequencies (up to 10 MHz) and input amplitudes (˜0.1 to 6Vpp), but may also use a wideband voltage divider. Because accurate resonance frequency detection depends on voltage drop across the internal output resistor (R₀) in voltage mode circuits, there is a reduction in voltage available for stimulation of the piezoelectric transducer, leading to a decline in acoustic trapping power when conducted simultaneously with resonance frequency detection. For a non-ideal amplifier with the no-load output of V_{S} and an output resistance of R₀, the voltage across the piezo transducer (Vₚ) can be expected to remain smaller than V_{S}. The measurement sensitivity (α) for the resonance frequency may be determined by the ratio of the change in Vₚ to the change in impedance magnitude (Zₚ) around the resonance frequency, where α is given as follows:

$$α = \frac{\% {ΔV}_{p}}{\% Δ {Z}_{p}} = ( 1 - \frac{{V}_{p}}{{V}_{s}} ) \qquad Eq . ( 1 )$$

Increasing measurement sensitivity (α) to enable improved detection of changes in Zₚ, based on measurement of Vₚ, may require larger voltage drop levels across R₀, which means that less voltage is available for stimulation of the piezo transducer. Since the delivered acoustic energy depends sharply on this stimulation voltage (∝Vₚ²), the trapping force may be greatly diminished, which becomes particularly apparent under conditions of flow, buffer swaps, or drift.

The signal generation circuitry 116 may provide real-time resonance frequency measurement and feedback control that is based on monitoring of the current drawn from the amplifier used to stimulate the piezo transducer, and avoid measurement and control based on the voltage drop across the output resistor. This use of current monitoring may be used to avoid affecting the voltage delivered to the piezo transducer. The measurement sensitivity (β) based on current (Iₚ) to the change in impedance magnitude around the resonance frequency (Zₚ), is given as follows:

$$β = \frac{\% Δ {I}_{p}}{\% Δ {Z}_{p}} = ( - \frac{{V}_{p}}{{V}_{s}} ) \qquad Eq . ( 2 )$$

Based on Eq. (2), the sensitivity (β) may be maximized by making R₀ as small as possible, to lead to the condition of: Vₚ≈V_{S}. Hence, both sensitivity and magnitude of Vₚ may be maintained independent of each other, thereby ensuring that the high measurement sensitivity does not reduce the power available for stimulation of the transducer. Rather than monitoring the output AC current of the amplifier, which may require a current-to-voltage conversion unit and a peak detector circuit with inaccurate measurement in the MHz range, the signal generation circuitry 116 may monitor the output AC current (Iₚ) based on the averaged value of power supply currents (I̅_̅{̅S̅}̅) into the amplifier 122. Since I̅_̅{̅S̅}̅ may be easily measured using conventional multimeters or DC circuits without requiring a wideband peak detector, the resonance frequency may be detected as the point at which I̅_̅{̅S̅}̅ reaches its maximum level. To enable easy access for I̅_̅{̅S̅}̅ measurements, the AC generator 120 and amplifier 122 may be integrated into signal generation circuitry 116 that can eventually be easily scaled to enable independent measurement and control of multiple microfluidic channels, each providing the ability to undergo different acoustic trapping operations in parallel. The signal generation circuitry 116 may also monitor and control surface bound modes used for acoustic streaming, where the resonance frequency of bulk transducers (i.e., piezoelectric and channel resonance of the entire device) may be more sensitive to flow conditions, due to the higher throughput possible in these microchannels.

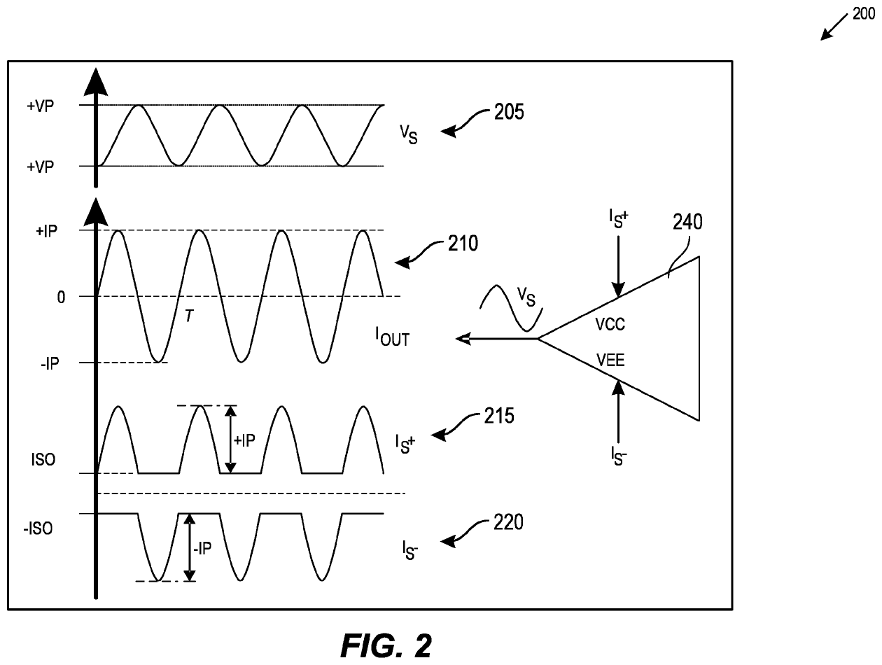

FIG. 2 is a diagram of a current and voltage waveforms 200, according to an example. Waveforms 200 include inputs to and outputs from amplifier 240, including amplifier output voltage (V_{S}) waveform 205, amplifier output current (Iₒᵤₜ) waveform 210, amplifier positive supply current (I_{S}+) input waveform 215, and amplifier negative supply current (I_{S}−) waveform 220. The input terminals amplifier 240 draw practically near zero current from the input source. According to Kirchhoff's Current Law (KCL), Iₚ may be expressed as the summation of two supply currents (I_{S}+ and I_{S}−) entering the respective amplifier supply pins. If no load is connected to the amplifier 240 (e.g., Iₒᵤₜ=0), the magnitude of both supply currents may remain at the steady value of I_{S0}. This value is dependent on output amplitude (V_{S}) and the working frequency. If a load is connected (e.g., Iₒᵤₜ≠0), then the supply currents are no longer DC values, but they take the shape of half wave rectified AC signal that includes either positive or negative cycles as shown in I_{S}+ waveform 215 and I_{S}− waveform 220. An outward current (e.g., Iₒᵤₜ>0) may be provided through the positive supply current (I_{S}+). As a result, I_{S}+ exactly follows the positive cycles of Iₒᵤₜ with a DC offset of +I_{S0}, while the negative supply current remains at the DC value of −I_{S0}, with no change, as shown in Iₒᵤₜ waveform 210 and I_{S}+ waveform 215. Conversely, the negative supply current will supply an inward current output in an analogous manner, as shown in Iₒᵤₜ waveform 210 and I_{S}− waveform 220. In other words, the active cycles in positive (I_{S}+) and negative (I_{S}−) supply currents will alternate with each other. Unlike the output AC current, which is oscillating around zero, the supply currents are bounded between I_{S0} and (I_{S0}+Iₚ). Hence, the supply currents have non-zero averages that may be computed based on integral of its waveform over one period, as shown in Eq. (3) below:

$$\overline{{I}_{S}} = \frac{1}{T} {\int }_{0}^{T} {I}_{S} dt = {I}_{S 0} + \frac{{I}_{P}}{π} \qquad Eq . ( 3 )$$

As indicated in Eq. (3), the averaged value of supply currents (I̅_̅{̅S̅}̅) can represent the amplitude of output AC current (Iₚ). By monitoring the averaged supply current (I̅_̅{̅S̅}̅) and finding its maximum value, the resonance frequency may be determined accurately at any moment based on the conditions in each microchannel.

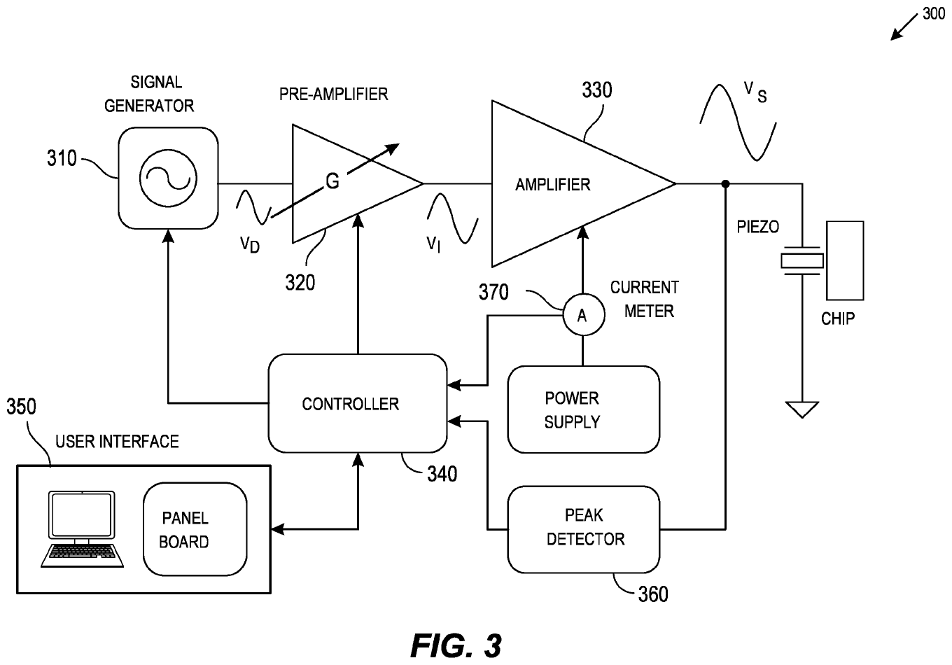

FIG. 3 is a block diagram of an acoustic trapping system 300, according to an example. The acoustic trapping system 300 may be used to provide automated signal stimulation and frequency tracking. The acoustic trapping system 300 may include a controller 340 (e.g., a microcontroller), which may continually read the analog DC voltage from the current meter 370 for real-time monitoring of AC current and for continuous tuning of the working frequency of the acoustic trapping system 300. The signal generator 310 may include a direct digital synthesis integrated circuit (IC), which may be serially programmed by the controller 340 to generate frequencies from DC to 10 MHz with the amplitude of 1Vₚₚ. This signal may be scaled up eight-fold by the pre-amplifier 320 that is fed into the custom high current amplifier 330. The pre-amplifier 320 may include multiple operational amplifier (op-amp) ICs cascaded together, and may include a variable gain amplifier that is adjusted by the controller 340. This allows a user at the user interface 350 to control the stimulation voltage from 0V to 20Vₚₚ, based on amount of acoustic force that is used in a variety of sample types, piezo sensors, and chip configurations. A peak detector 360 may be included to measure amplitude of the stimulation voltage, which may enable gain adjustment based on the desired acoustic trapping force. Because the amplitude estimation provided by peak detector 360 does not contribute to the detection of resonance frequency or to the automated frequency tracking, the peak detector 360 may be excluded.

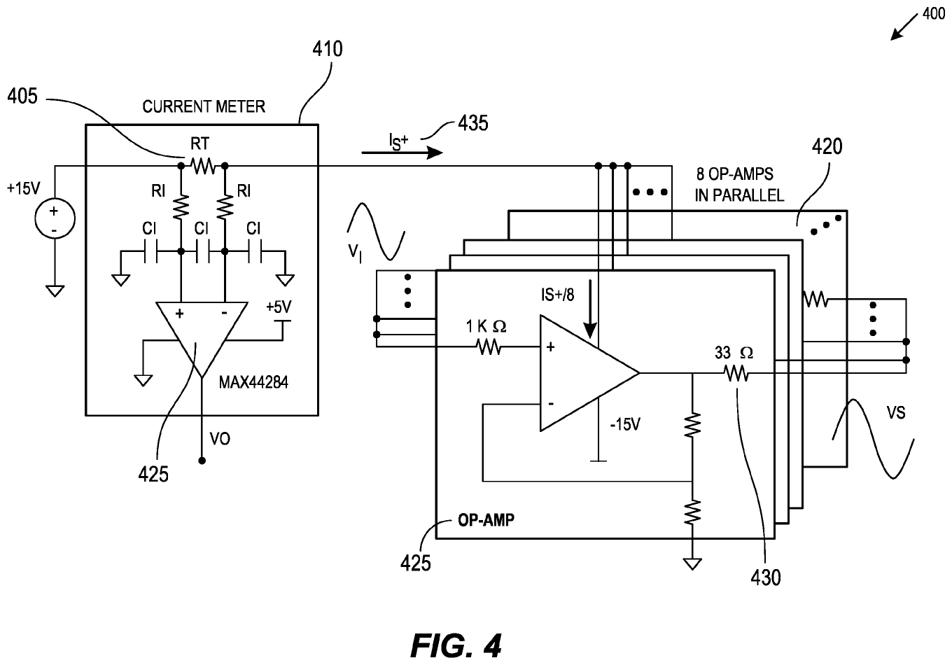

FIG. 4 is a circuit diagram of an acoustic trapping system 400, according to an example. The acoustic trapping system 400 includes a current meter 410 and a parallel amplifier array 420. In an example, the parallel amplifier array 420 may include eight op-amps 425 arranged in parallel. The current monitoring provided by acoustic trapping system 400 relies on direct access to the supply pins of each op-amp, and the output impedance of each op-amp is comparable with the resonance impedance of typical piezo transducers used for acoustic trapping (e.g., tens of ohms). The parallel amplifier array 420 enables direct access to the op-amp supply pins and provides sufficient current to a piezoelectric load (e.g., at least 0.2 A), while having a low output resistance (e.g., ˜452) to reduce or minimize wastage of voltage. The parallel amplifier array 420 boost the output current capability into the MHz range, where each of the eight op-amps 425 provides ⅛^{th} of the total output current (e.g., ˜140 mA) at maximum output voltage (e.g., ˜20Vₚₚ) around the resonance frequency of the piezoelectric transducer. While the parallel amplifier array 420 is shown and described as including eight op-amps 425, more op-amps or fewer op-amps may be used within the parallel amplifier array 420, such as to further reduce the output current or operating temperature for each op-amp.

The parallel amplifier array 420 further enables improved thermal performance, as each of the eight op-amps 425 may be selected to tolerate ⅛^{th} of the total power dissipation. Each of the eight op-amps 425 may include a dual-in-line (DIP) package type, which provides improved thermal resistance compared to corresponding surface-mount devices. The wider surface area of these DIP packages allows improved cooling, and may be improved further by attaching heatsinks to the top of each DIP package.

Each of the eight op-amps 425 may have an associated series resistor 430 (e.g., 8Ω) at the output of each op-amp to provide improved isolation among these eight op-amps 425, resulting in an overall output resistance for the parallel amplifier array 420 of ⅛^{th} the value of each associated series resistor 430 (e.g., total 33/8≈4Ω). To measure the averaged positive supply current 435 to the parallel amplifier array 420, a test resistor 405 (e.g., R_{T}=0.2Ω) is in the path of positive supply current 424. The small voltage across test resistor 405 (e.g. ˜25 mV) is then captured, filtered, and amplified within each of the eight op-amps 425.

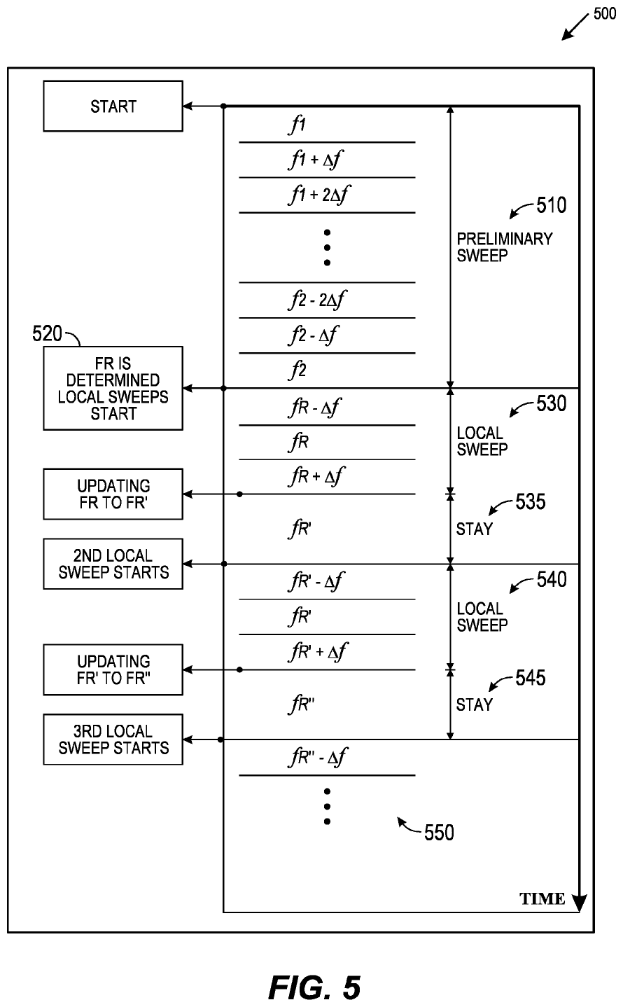

FIG. 5 is a diagram of a tracking and control sequence 500, according to an example. The tracking and control sequence 500 shows an example sequence for real-time tracking and control of the resonance frequency at each microchannel position. The tracking and control sequence 500 may be implemented by a controller (e.g., microcontroller), such as to provide real-time tracking and control of the resonance frequency.

The tracking and control sequence 500 begins with a preliminary sweep 510 to find the initial resonance frequency of the system, such as by sweeping the frequency between two pre-defined values of f₁ (e.g., default of 7.7 MHZ) and f₂ (e.g., default of 8.2 MHZ), with the frequency step of Δf (e.g., default of 20 KHz for resonance frequency of current transducer chip at ˜8 MHz). The sweep speed may be controlled by the time interval Tp (e.g., default: 0.2 s), where circuit pauses at each frequency point. At each frequency point, the averaged supply current I̅_̅{̅S̅}̅ is monitored by the microcontroller. At the end of the preliminary sweep 510, the initial resonant frequency f_{R} is detected 520 based on the maximum value among all I̅_̅{̅S̅}̅ values. Following this, a series of consecutive local sweeps track and update the momentary resonance frequency, such as first local sweep 530, second local sweep 540, third local sweep 550, and additional local sweeps. Each local sweep may include three frequency points of f_{R}−Δf, f_{R} and f_{R}+Δf. Upon completion of each local sweep, the system stays at the updated resonance frequency f′_{R} for the user defined time Ts (e.g., default of 0.4 s) before starting the next local sweep, such as at first stay state 535, second stay state 545, and additional stay states. Because the stimulation frequency remains locked to the momentary resonant frequency of the system, any drift in resonant frequency over the course of acoustic trapping may be detected and controlled to maintain trapping.

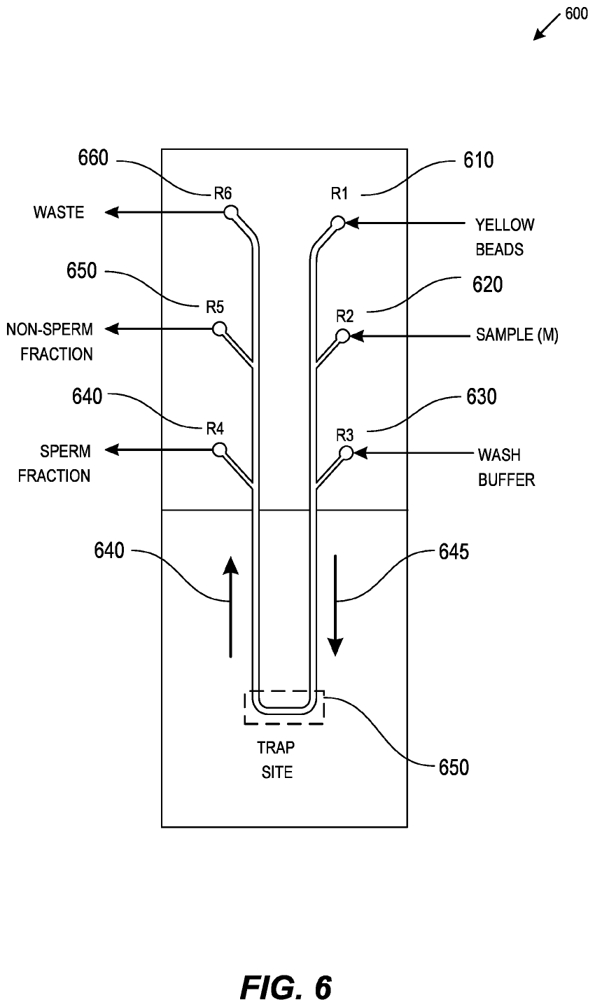

FIG. 6 is a diagram of a microfluidic device 600, according to an example. Within the microfluidic device 600, the first reservoir R1 610 may contain 6 μm yellow beads (e.g., Fluoresbrite), which may be used as a marker to determine the resonance frequency. The second reservoir R2 620 may contain the sample of sperm cells mixed with epithelial cell lysate. The third reservoir R3 630 may contain a wash buffer to remove any extraneous epithelial cellular material from trapped sperm cells. Initially, a local frequency sweep determines the approximate resonant frequency using yellow beads routed via pneumatic valving to the waste reservoir R6 660. Another local frequency sweep may then be used to set the feedback mechanism of the microfluidic device 600, as the sample is traversing the trapping site. Sperm cells may be trapped and held together in the trapping site, so that the female epithelial debris may be routed into another reservoir R5 650 for quantifying the female fraction. The buffer may then be passed over the sperm cluster for washing, and sperm cells may be released into reservoir R4 640 for downstream processing by nucleic acid analysis.

The microfluidic device 600 may be fabricated by laser cutting the channel into a thin (e.g., ˜280 μm) sheet of polydimethylsiloxane (PDMS), which may be sandwiched between two portions of microscope cover glass and bonded using plasma treatment. A buffer change may be simulated using 10% glycerol buffer. The reservoirs may be fabricated by laser cutting 3 mm (poly)methyl methacrylate (PMMA) and attaching the reservoirs to the glass using pressure sensitive adhesive. Visualization of the acoustically trapped cluster may be achieved with a camera placed above the trapping site of the chip. Syringe pumps may be attached to first reservoir R1 610, second reservoir R2 620, and third reservoir R3 630, and may be used to move fluid through the chip, such as at flow rates of 45 μL/min for sample trapping and 100 μL/min for elution.

In an example, using a current-based real-time control to correct for drift of the resonance frequency due to the increasing size of the trapped cluster of particles, the current-based control provides a continuous growth in cluster size. In contrast, a voltage-based control would provide slower growth of a trapped cluster of particles, and result in saturation of the trapping level. While operating in current-based control mode, the shifting resonance frequency may display a smooth downward trend, which indicates continued growth of the trapped cluster of particles. In contrast, the voltage-based control causes the resonance frequency to reach a steady-state level, which results in a plateauing of growth of the trapped cluster of particles, as the lower trapping force provided by the voltage-based control causes an earlier steady-state condition from the balance between the drag force and radiation force.

The current-based control provided by microfluidic device 600 provides improved performance during a wash step. A wash step in the microchannel may include increasing the flow rate, such as doubling the flow rate from 30 μL/min to 60 μL/min after 20 s of trapping. This flow rate increase may be used to compare current-based control with voltage-based control two modes for maintaining particle trapping based on cluster size images and the resonance frequency alterations. This wash step causes the dissipation of trapping under the voltage-based control, but under current-based control the resonant frequency alterations may be detected for real-time control of stimulation, thereby maintaining the particle trapping.

The current-based control provided by microfluidic device 600 provides improved performance during resonant frequency disruptions. Disruptions to the resonant frequency for particle trapping under a buffer switch may be simulated by using 10% glycerol buffer. This alteration in the liquid density in the microchannel may be accounted for in real-time to maintain trapping using the current-based control, as apparent from the continued drop in resonant frequency of the system. In contrast, this alteration in the liquid density in voltage-based control may cause dissipation of the trapped cluster into smaller clusters, resulting in disruption of the resonant frequency shift, observed as a frequency increase.

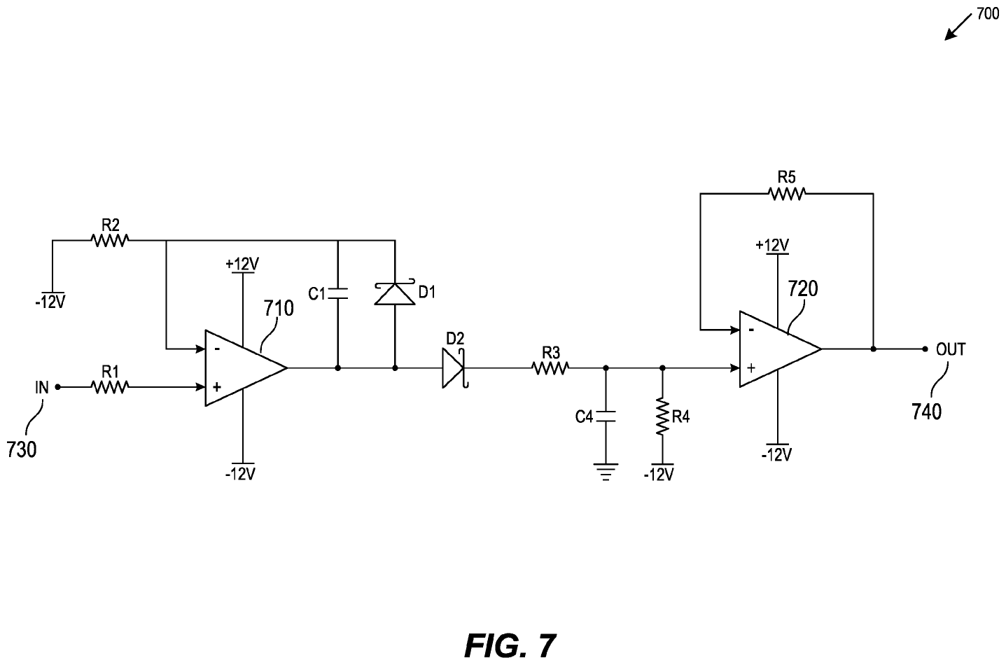

FIG. 7 is a circuit diagram of a first peak detector 700, according to an example. The first peak detector 700 includes a first op-amp 710 and a second op-amp 720, and the absolute error (e.g., accuracy) may include a difference between the DC output 740 of second op-amp 720 and the voltage amplitude of the input signal 730 of the first op-amp 710. In an example, the accuracy of the first peak detector 700 may be relatively low (e.g., error˜−300 mV) for low input amplitude (e.g., 0V-6V) throughout the relevant frequency range of 1-10 MHz. The error may increase for higher input amplitudes (e.g. beyond 6V) as the frequency increases beyond 7 MHz for higher.

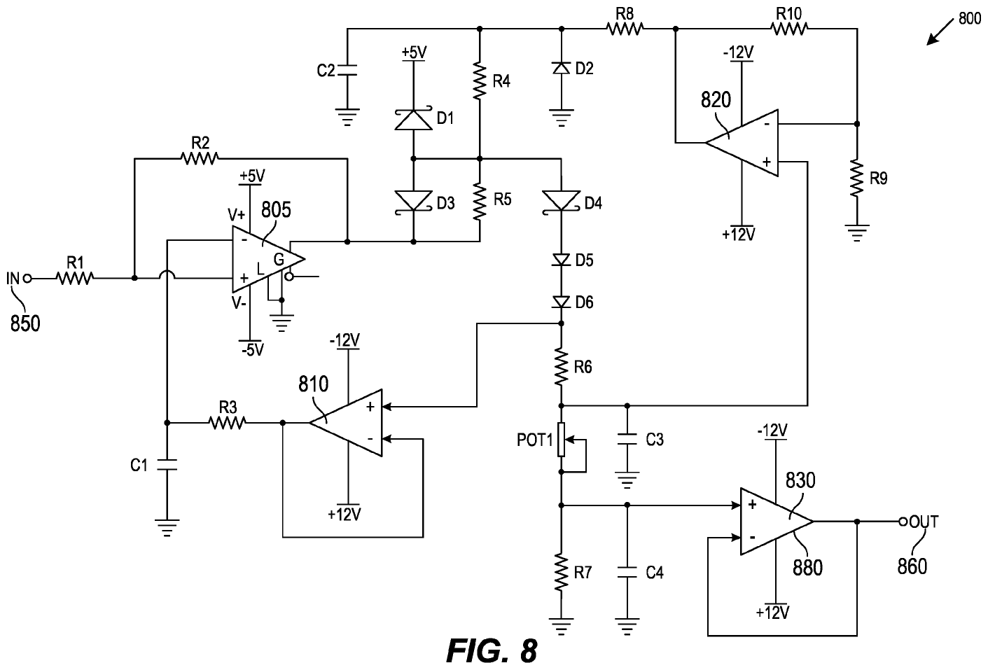

FIG. 8 is a circuit diagram of a second peak detector 800, according to an example. The second peak detector 800 includes a comparator 805 with a small propagation delay (e.g., 7 nanoseconds), a first sub-amplifier 810, a second sub-amplifier 820, and a third sub-amplifier 830. The second sub-amplifier 820 provides an injected boosting current into a charge holder capacitor C3 840 that independent of the voltage of charge holder capacitor C3 840. This this injected boosting current enables the charging current to remain high as the capacitor voltage reaches the target voltage of the input 850, which maintains the ability for charge holder capacitor C3 840 to be fully charged and reduces the absolute error between input 850 and output 860. In contrast with first peak detector 700, the second peak detector 800 provides improved performance over various input voltage amplitudes throughout the relevant frequency range of 1-10 MHz while avoiding the reduced performance as the frequency increases beyond 7 MHz for higher.

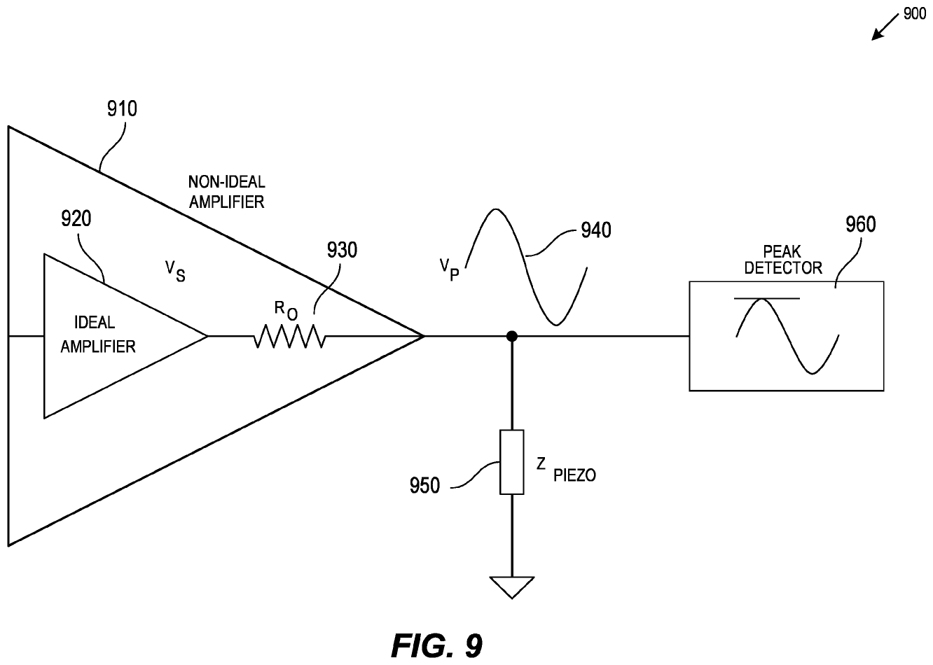

FIG. 9 is a diagram of a non-ideal amplifier circuit 900, according to an example. The non-ideal amplifier circuit 900 includes a non-ideal amplifier 910 that is modeled as a combination of an ideal amplifier 920 (e.g., Vout=Vs) and an output resistor 930 with resistance R₀. The amplitude of AC signal Vₚ 940 across piezoelectric transducer 950 as seen at peak detector 960 may be calculated based on the voltage division between R₀ and the piezoelectric impedance Z_{Piezo} of the piezoelectric transducer 950:

$${V}_{p} = {V}_{s} ( \frac{\vert {Z}_{Piezo} \vert}{\vert {Z}_{P i e z o} + {R}_{o} \vert} ) \qquad Eq . ( 4 )$$

Based on Eq. (4), as the frequency of the non-ideal amplifier 910 approaches the resonance frequency, the impedance becomes mostly resistive in its minimum magnitude Z_{Piezo}, which will result in the amplitude of Z_{Piezo} also reaching a minimum.

The amount of current drawn from the ideal amplifier 920 causes the voltage drop across output resistor 930 to be maximized at the resonance frequency. By comparing voltage drops at various frequencies and identifying the local minimum of voltage amplitude across the piezoelectric transducer 950, the optimum frequency of trapping may be determined.

The non-ideal amplifier circuit 900 may provide improved (e.g., reduced) voltage sensitivity to any changes in the piezoelectric impedance Z_{Piezo} of the piezoelectric transducer 950. By taking the differential from of both sides of Eq. (4),

$${d V}_{p} = {V}_{s} ( \frac{{R}_{o}}{{( {Z}_{p} + {R}_{o} )}^{2}} ) \cdot {dZ}_{p} \qquad Eq . ( 5 )$$

and dividing both sides of Eq. (5) by the corresponding sides of Eq. (4) yields:

$$\frac{{d V}_{p}}{{V}_{p}} = ( \frac{{R}_{o}}{{( {Z}_{p} + {R}_{o} )}^{2}} ) \cdot {dZ}_{p} / ( \frac{{Z}_{p}}{{Z}_{p} + {R}_{o}} ) = \frac{d {Z}_{p}}{{Z}_{p}} ( \frac{{R}_{o}}{{Z}_{p} + {R}_{o}} ) \qquad Eq . ( 6 )$$

Using Eq. (4) and Eq. (6), we can relate the sensitivity of Vp and Zp, based on Vp and Vs as follows:

$$\frac{{d V}_{p}}{{V}_{p}} = \frac{d {Z}_{p}}{{Z}_{p}} ( 1 - \frac{{V}_{p}}{{V}_{s}} ) \qquad Eq . ( 7 )$$

$$\frac{\% Δ {V}_{p}}{\% Δ {Z}_{p}} = ( 1 - \frac{{V}_{p}}{{V}_{s}} ) = α \qquad Eq . ( 8 )$$

As shown in Eq. (8), the relative change in Vp is smaller than the relative change in the impedance magnitude Zp by the factor of a, where the factor α is between 0 and 1. For example, if α=0.5, a 10% change in the impedance would result in a 5% change in the measured peak voltage Vp. This demonstrates the reduced voltage sensitivity to changes in the piezoelectric impedance Z_{Piezo} of the piezoelectric transducer 950.

The non-ideal amplifier circuit 900 may provide improved current measurement accuracy through improved (e.g., increased) current sensitivity. The output current Ip from non-ideal amplifier 910 may be expressed as follows:

$${I}_{p} = {V}_{s} ( \frac{1}{{Z}_{P} + {R}_{o}} ) \qquad Eq . ( 9 )$$

By taking the differential form and dividing as in Eq. (5) through Eq. (8) above, the sensitivities of Ip and Zp are determined as follows:

$$\frac{{dI}_{p}}{{I}_{p}} = ( \frac{- {dZ}_{p}}{{( {Z}_{p} + {R}_{o} )}^{2}} ) / ( \frac{1}{{Z}_{p} + {R}_{o}} ) = \frac{- {dZ}_{p}}{{Z}_{p}} ( \frac{{Z}_{p}}{{Z}_{p} + {R}_{o}} ) \qquad Eq . ( 10 )$$

$$\frac{{dI}_{p}}{{I}_{p}} = \frac{d {Z}_{p}}{{Z}_{p}} ( \frac{- {V}_{p}}{{V}_{s}} ) \qquad Eq . ( 11 )$$

$$\frac{\% Δ {I}_{p}}{\% Δ {Z}_{p}} = ( - \frac{{V}_{p}}{{V}_{s}} ) = β \qquad Eq . ( 12 )$$

Eq. (12) shows that the maximum sensitivity in the Ip measurement is expected when Vp is maximized, which in turn is based on a minimization of output resistor 930. This provides improved current measurement accuracy even in the presence of relatively high Vp magnitude.

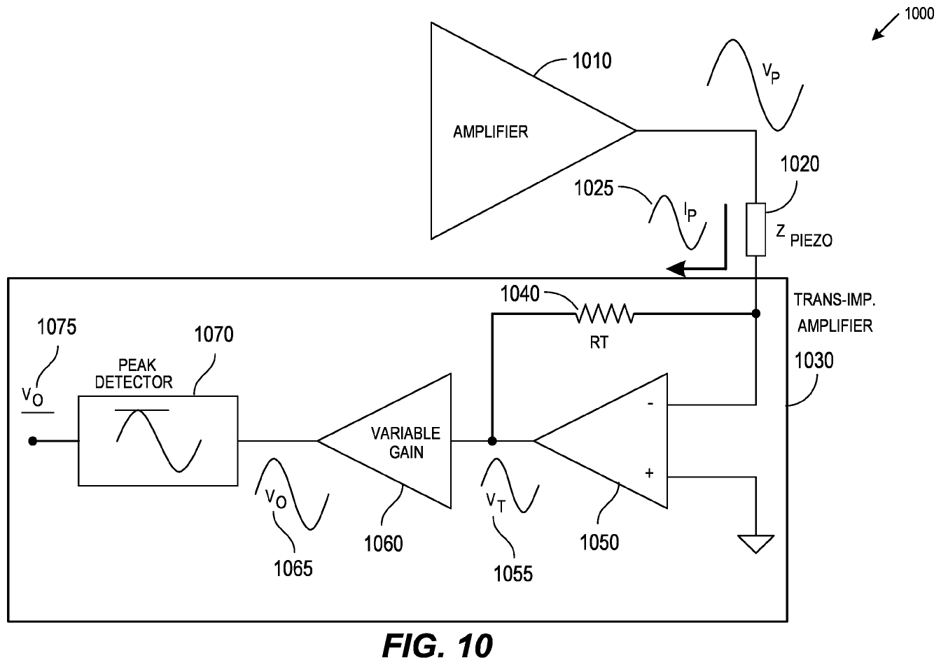

FIG. 10 is a diagram of an alternating current (AC) measurement circuit 1000, according to an example. The measurement circuit 1000 may be used to measure the AC output provided from the amplifier 1010 through the piezoelectric element 1020. A trans-impedance amplifier 1030 may use a test resistor 1040 and an impedance amplifier 1050 to convert a current signal I_{P} 1025 into a voltage signal V_{T} 1055. A variable gain amplifier 1060 may convert the voltage signal V_{T} 1055 into an AC voltage signal V_{O} 1065. A peak detector 1070 may receive the output voltage signal V_{O} 1065 and output a peak voltage value V_{O} 1075. The impedance amplifier 1050 may be selected to provide a wide bandwidth and extremely low bias current (e.g., ˜1 pico-ampere). The variable gain amplifier 1060 may allow adjusting the input amplitude of the AC voltage signal V_{O} 1065 that is input into the peak detector 1070.

To provide improved current measurement, the impedance amplifier 1050 may be selected to generate an output swing as large as 20 Vpp. In an example, generating such a large output voltage swing may be improved by using a dual power supply with symmetrical voltage levels of ±12V to ±15V. At the resonance frequency of the piezoelectric element 1020, the impedance magnitude may reach a minimum value while becoming more resistive than reactive. This reduced impedance value may cause a higher AC current value to be drawn from the amplifier 1010. In an example, the piezoelectric element 1020 used in the acoustic trapping system described herein may have an associated the piezo impedance of around 70Ω. For a stimulation voltage of 20Vpp (e.g., Vp=10V), the AC current may have a peak amplitude of approximately 140 mA, which is within the operating range of measurement circuit 1000.

The impedance amplifier 1050 may be selected to have an associated large-signal bandwidth that is high enough to provide a flat frequency response up to 9-10 MHz for high voltage output. The impedance amplifier 1050 may also provide high output current capability, and may employ precise control of the power dissipation of amplifier 1010. The total power dissipation (P_{D}) may be expressed as the difference between the amount of power from the power supply (through Vcc and Vee terminals) into the amplifier and the delivered power to the impedance load (P_{Load}) as shown in Eq. (13):

$${P}_{D} = {P}_{supply} - {P}_{Load} = 2 {V}_{cc} ( {I}_{S 0} + \frac{{I}_{P}}{π} ) - \frac{1}{2} {V}_{p} {I}_{p} cos θ \qquad Eq . ( 13 )$$

In Eq. (13), I_{S0} is the DC component of supply current (e.g., the quiescent current), and Ip is the amplitude of output AC current. In the second term, the parameter θ is the phase shift between the AC voltage and AC current at the output. For a capacitive load, this phase shift may track the resonance frequency but remain about 90 degrees offset from the resonance frequency. For a resistive load, this phase shift may remain closer to 0 digress offset from the resonance frequency.

By substituting working parameters Vcc=15, Ip=140 mA, Vp=10V and θ=0 into Eq. (13), a simplified expression for calculation of dissipated power is obtained:

$${P}_{D} = 2 {V}_{cc} ( {I}_{S 0} + \frac{{I}_{P}}{π} - \frac{{V}_{p} {I}_{p}}{4 V cc} {\overbrace{cos 0}}^{1} ) ≅ 3 {0}^{V} ( {I}_{S 0} + 2 {1}^{mA} ) \qquad Eq . ( 14 )$$

As shown in Eq. (14), the DC quiescent current is an important consideration in reducing or minimizing the power dissipation. However, apart from this DC power dissipation, the small impedance of load would dissipate more than ˜600 mW heat inside the amplifier. The measurement circuit 1000 should therefore be selected to provide increased heat dissipation. A single amplifier module may be used that could operate with high supply voltage levels (e.g., up to ±100V), 1.5 A output current capability, and maximum dissipated heat of 62 W, however this may result in power loss at particle trapping frequencies (e.g., 7.5-8 MHz). An amplifier may be selected to provide stability in relatively low gain values so that a more generous portion of its bandwidth is suitable for large signal amplification. Based on Eq. (14), the maximum power dissipation may be around 850 mW (e.g. I_{S0}=6.5 mA), so any single amplifier should be selected to handle this maximum power dissipation.

To provide sufficient power dissipation, an array of parallelized amplifiers may be used so that each sub-amplifier IC contributes by providing a fraction of the overall output current, such as the parallel amplifier array 420 shown in FIG. 4. Additionally, a dual in-line package (DIP) may be selected to provide improved thermal resistance compared to smaller surface-mount amplifiers. To further improve thermal management, the array of amplifiers may be subdivided into groups, such as subdividing eight DIP amplifiers into two groups of four amplifiers each, and each subgroup may be attached to a corner of a shared rectangular heatsink. The inputs and outputs of all amplifiers may be tied together in this parallel arrangement, and may share a common feedback structure (e.g., gain=2.5) using precision resistors (e.g., 0.1%).

Using this parallel amplifier configuration, each of the amplifiers may share a substantially common phase and amplitude. However, the amplifier output signals may not be identical due to the intrinsic tolerances in the fabrication of ICs and resistors. To improve consistency, a small resistor may be connected to the output of each amplifier to provide isolation and minimize or prevent any over-current issues, such as associated series resistor 430 shown in FIG. 4. These protection resistors result in an effective resistance of 4Ω (=33/8) at the output of the array of amplifiers. The non-inverting feedback in each amplifier (e.g., amplifier transfer gain) may be Av=2.5, which may improve the power bandwidth efficiency of the amplifiers. Each amplifier may be responsible for providing ⅛^{th} of the current output (e.g., ˜18 mA (=140/8)) around the resonance frequency. Following Eq. (12), this AC current may results in a dissipated power of ˜275 mW inside each IC that may be dissipated without significantly raising the operating temperature of the array, especially when combined with common heat sinks among the subgroups of amplifiers.

A custom amplifier may be used to provide access to all internal terminals and nodes of the system, including the supply pins. The maximum averaged current (I̅_̅{̅S̅}̅max) into such a custom amplifier may be around 100 mA, according to Eq. (15):

$$\overline{{I}_{S}} max = 8 \times {I}_{S 0} + \frac{{I}_{P}}{π} ≅ 8 \times 6 . {5}^{m A} + \frac{14 {0}^{m A}}{π} ≅ 10 {0}^{m A} \qquad Eq . ( 15 )$$

To measure the averaged current (I̅_̅{̅S̅}̅), a small test resistor (RT=0.25Ω) may be disposed in series within the positive supply line to produce a voltage equivalent (V_{RT}) of supply current. The maximum of this voltage drop would be around ˜25 mV, which is negligible compared to Vcc (+15V), thereby not affecting the amplifier's performance. To provide improved accuracy in measuring V_{RT}, a high precision current-sense amplifier may be used to amplify the input differential voltage with a substantial fixed gain (e.g., gain of 50). A low input bias current (e.g., ≤80 nA) may be used to reduce or eliminate wasted or leaked current during current-to-voltage conversion. The amplifier may also reject the common-mode DC voltage on its input terminals (e.g., +15V) while operating with only a lower voltage single supply (e.g., +5V). If a megahertz ripple on the supply current is beyond the amplifier's sensible bandwidth (e.g., ˜3 kHz), a low-pass filter (e.g., 3 db˜1 KHz) may be added at the input terminals to suppress transient noise or interferences. The current-meter unit output may be a DC voltage ranging from ˜0.65V to 1.2V, representing the amplifier's momentary averaged supply current.

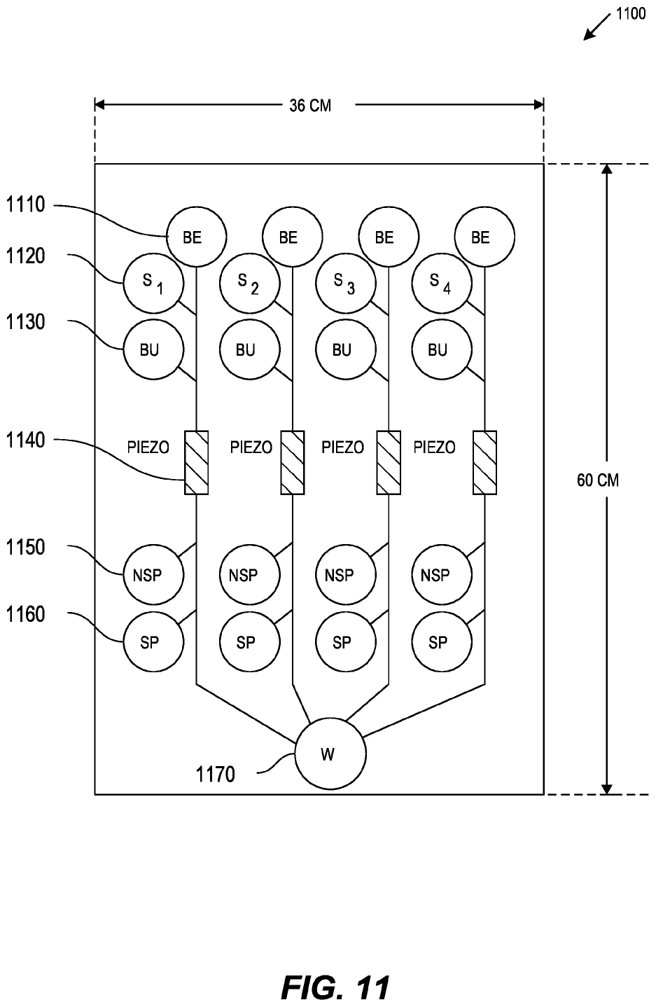

FIG. 11 is a diagram of a multi-channel acoustic-fluidic chip 1100, according to an example. The acoustic-fluidic chip 1100 may include an array of bead reservoirs 1110, each containing beads to be used as a marker to determine the resonance frequency. An array of sample sites 1120 may be used to receive samples, such as samples of sperm cells mixed with epithelial cell lysate. An array of wash buffer reservoirs 1130 may be used to remove any extraneous epithelial cellular material from trapped sperm cells.

An array of piezoelectric transducers 1140 may be used to determine an approximate initial resonant frequency. In an example, a local frequency sweep determines the approximate resonant frequency using yellow beads routed via pneumatic valving from the array of bead reservoirs 1110, to a waste reservoir 1170. A separate local frequency sweep may then be used to set the feedback mechanism of the acousto-fluidic chip 1100, such as when as the sample is traversing the trapping site.

An array of non-sperm cell reservoirs 1150 may be used to retain non-sperm cells, which may include female epithelial cells for quantifying the female fraction. An array of sperm cell reservoirs 1160 may be used to retain sperm cells. In an example, the buffer may be passed over sperm clusters within sperm cell reservoirs 1160 for washing, after which sperm cells may be released for downstream processing by nucleic acid analysis.

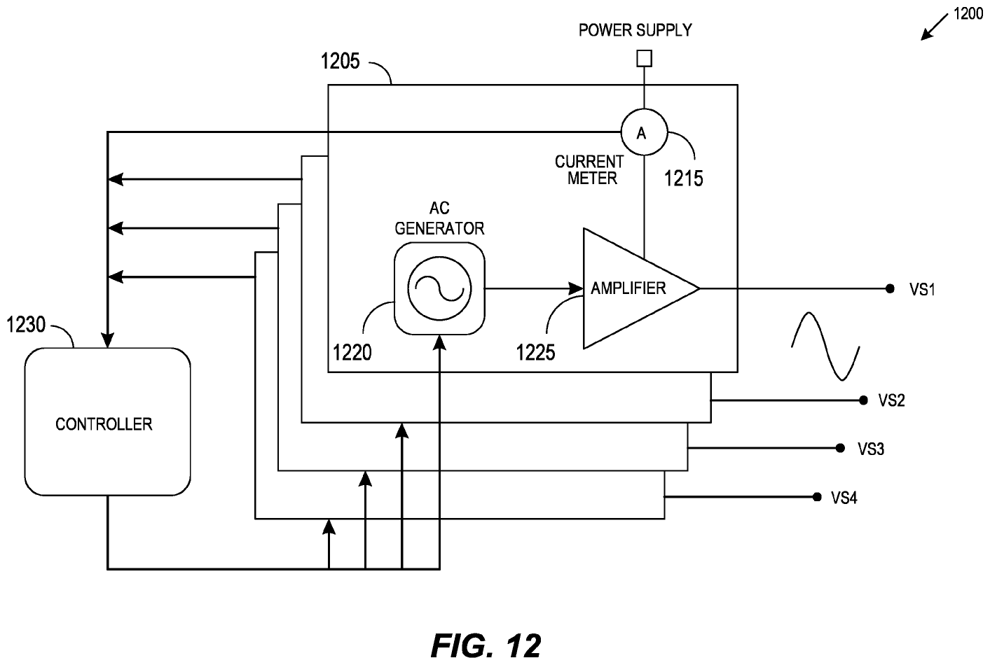

FIG. 12 is a block diagram of an acoustic trapping array 1200, according to an example. In the example shown in FIG. 12, the acoustic trapping array 1200 includes four independent modules 1205. Each of the four independent modules 1205 includes a current meter 1215, an AC generator 1220 (e.g., stimulation unit), and an amplifier 1225.

Information from each current meter 1215 will be used by a common controller 1230 to determine and revise the resonant frequency for each of the four independent modules 1205 based on real-time current measurements. Because the resonant frequency may vary among the four independent modules 1205, the use of four independent modules 1205 provides improved acoustic particle trapping reliability and performance.

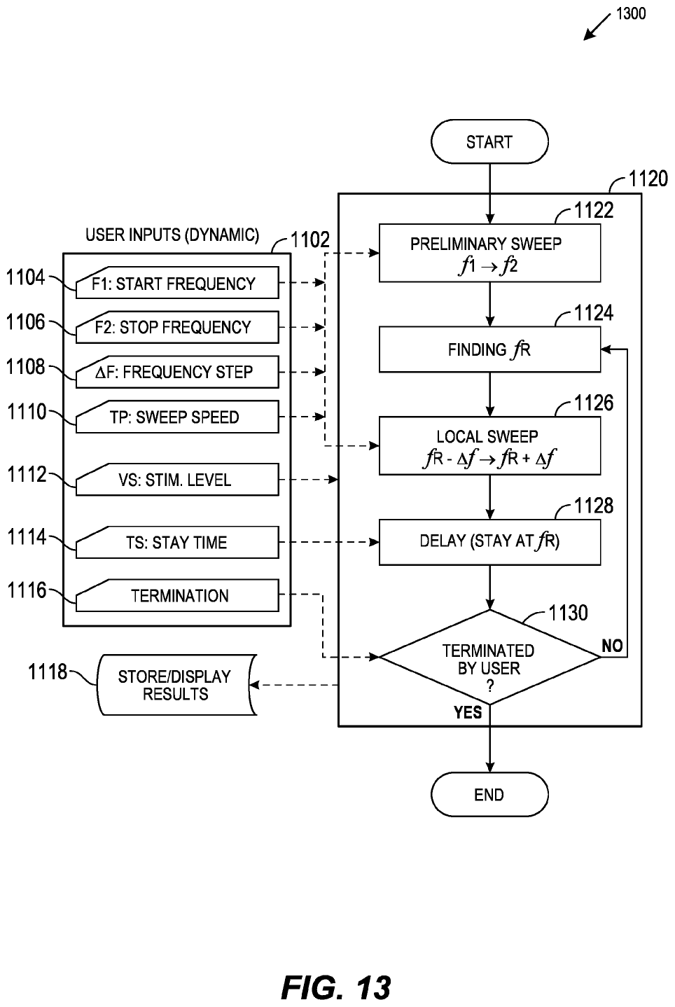

FIG. 13 is a resonance frequency tracking flowchart 1300, according to an example. The resonance frequency tracking flowchart 1300 may receive a series of dynamic user input 1302 at various steps within the resonance frequency tracking method 1320. A single preliminary frequency sweep 1322 may sweep the frequency from start frequency 1304 to stop frequency 1306 to find the resonant frequency 1324. Subsequently, a local sweep 1326 may be performed based on the resonant frequency 1324, a frequency step 1308, a sweep speed 1310, and a stimulation level 1312. Following the local sweep 1326, the detected resonant frequency may be maintained for a delay 1328 whose duration is provided by input stay time 1314. Following delay 1328, the resonance frequency tracking method 1320 may determine if a termination signal 1330 has been received. If no termination signal 1330 has been received, the resonance frequency tracking method 1320 may repeat resonant frequency 1324, local sweep 1326, and delay 1328. The resonance frequency tracking method 1320 may also store or display results 1318 of the identified resonance frequency.

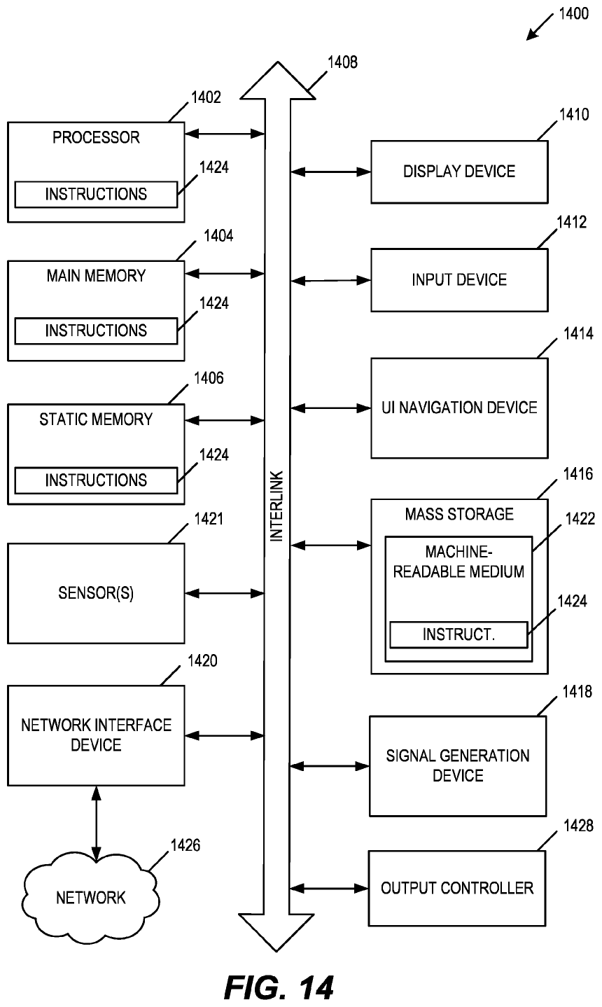

FIG. 14 illustrates an example of a block diagram of a machine 1400 upon which any one or more of the techniques (e.g., methodologies) discussed herein may perform according to an example. In other examples, the machine 1400 may operate as a standalone device or may be connected (e.g., networked) to other machines. In a networked deployment, the machine 1400 may operate in the capacity of a server machine, a client machine, or both in server-client network environments. The machine 1400 may be a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or like mechanisms. Such mechanisms are tangible entities (e.g., hardware) capable of performing specified operations when operating. In an example, the hardware may be specifically configured to carry out a specific operation (e.g., hardwired). In an example, the hardware may include configurable execution units (e.g., transistors, circuits, etc.) and instructions contained on a computer readable medium, where the instructions configure the execution units to carry out a specific operation when in operation. The configuring may occur under the direction of the execution units or a loading mechanism. Accordingly, the execution units are communicatively coupled to the computer readable medium when the device is operating. For example, under operation, the execution units may be configured by a first set of instructions to implement a first set of features at one point in time and reconfigured by a second set of instructions to implement a second set of features.

Machine (e.g., computer system) 1400 may include a hardware processor 1402 (e.g., a central processing unit (CPU), a graphics processing unit (GPU), a hardware processor core, or any combination thereof), a main memory 1404 and a static memory 1406, some or all of which may communicate with each other via an interlink (e.g., bus) 1408. The machine 1400 may further include a display unit 1410, an alphanumeric input device 1412 (e.g., a keyboard), and a user interface (UI) navigation device 1414 (e.g., a mouse). In an example, the display unit 1410, alphanumeric input device 1412 and UI navigation device 1414 may be a touch screen display. The display unit 1410 may include goggles, glasses, an augmented reality (AR) display, a virtual reality (VR) display, or another display component. For example, the display unit may be worn on a head of a user and may provide a heads-up-display to the user. The alphanumeric input device 1412 may include a virtual keyboard (e.g., a keyboard displayed virtually in a VR or AR setting.

The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or another sensor. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices.

The storage device 1416 may include a machine readable medium 1422 that is non-transitory on which is stored one or more sets of data structures or instructions 1424 (e.g., software) embodying or used by any one or more of the techniques or functions described herein. The instructions 1424 may also reside, completely or at least partially, within the main memory 1404, within static memory 1406, or within the hardware processor 1402 during execution thereof by the machine 1400. In an example, one or any combination of the hardware processor 1402, the main memory 1404, the static memory 1406, or the storage device 1416 may constitute machine readable media.

While the machine readable medium 1422 is illustrated as a single medium, the term “machine readable medium” may include a single medium or multiple media (e.g., a centralized or distributed database, or associated caches and servers) configured to store the one or more instructions 1424.

The term “machine readable medium” may include any medium that is capable of storing, encoding, or carrying instructions for execution by the machine 1400 and that cause the machine 1400 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420 using any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, as the personal area network family of standards known as Bluetooth® that are promulgated by the Bluetooth Special Interest Group, peer-to-peer (P2P) networks, among others. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1400, and includes digital or analog communications signals or other intangible medium to facilitate communication of such software.

Each of these non-limiting examples may stand on its own, or may be combined in various permutations or combinations with one or more of the other examples.

Example 1 is a system for acoustic trapping microchannel resonance detection and control, the system comprising: a signal generator to generate an alternating current signal; a transducer amplifier to generate a first trapping signal based on the alternating current signal; and a piezoelectric transducer disposed on a microfluidic substrate to generate a first acoustic standing wave at a first resonance frequency based on the first trapping signal, the first acoustic standing wave to separate a first particle type from a second particle type.

In Example 2, the subject matter of Example 1 includes, a peak detector to determine a peak voltage based on the first trapping signal; a controller to generate a first variable gain control signal based on the peak voltage; and a variable gain amplifier to generate a first variable gain voltage signal based on the first variable gain control signal and the alternating current signal, wherein the transducer amplifier generates the first trapping signal based on the first variable gain voltage signal.

In Example 3, the subject matter of Example 2 includes, wherein the controller is further configured to: provide a first control signal sweep through a first sequence of frequencies to the variable gain amplifier; receive a first plurality of peak voltages from the peak detector; identify the first resonance frequency based on the first plurality of peak voltages; and generate the first variable gain control signal based on the first resonance frequency.

In Example 4, the subject matter of Example 3 includes, wherein the controller is further configured to: provide a second control signal sweep through a second sequence of frequencies to the variable gain amplifier; receive a second plurality of peak voltages from the peak detector; identify a second resonance frequency based on the second plurality of peak voltages, the second resonance frequency different from the first resonance frequency; generate a second variable gain control signal based on the second resonance frequency; cause the variable gain amplifier to generate a second variable gain voltage signal based on the second variable gain control signal; and cause the transducer amplifier to generate a second trapping signal at the second resonance frequency based on the second variable gain voltage signal.

In Example 5, the subject matter of Examples 2-4 includes, wherein the peak detector includes a current boosting amplifier to reduce an absolute error of the peak detector.

In Example 6, the subject matter of Examples 2-5 includes, a current meter to generate a current signal based on a power supply current provided to the transducer amplifier, wherein the controller generating the first variable gain control signal is further based on the current signal.

In Example 7, the subject matter of Examples 1-6 includes, wherein the transducer amplifier includes a plurality of sub-amplifiers disposed in parallel.

In Example 8, the subject matter of Examples 1-7 includes, a coupling layer, the piezoelectric transducer disposed on the coupling layer; a reflecting layer disposed opposite from the coupling layer, the reflecting layer to reflect the first acoustic standing wave back to the piezoelectric transducer.

In Example 9, the subject matter of Examples 1-8 includes, a sample pump to convey a particle sample through the first acoustic standing wave, the particle sample including the first particle type and the second particle type.

In Example 10, the subject matter of Example 9 includes, a first reservoir to retain the first particle type after separation by the piezoelectric transducer; and a second reservoir to retain the second particle type after separation by the piezoelectric transducer.

Example 11 is a method for acoustic trapping microchannel resonance detection and control, the method comprising: generating an alternating current signal at a signal generator; generating a first trapping signal at a transducer amplifier based on the alternating current signal; generating a first acoustic standing wave at a first resonance frequency at a piezoelectric transducer disposed on a microfluidic substrate based on the first trapping signal; and passing a particle sample through the first acoustic standing wave to separate a first particle type from a second particle type.

In Example 12, the subject matter of Example 11 includes, determining a peak voltage at a peak detector based on the first trapping signal; generating a first variable gain control signal at a controller based on the peak voltage; and generating a first variable gain voltage signal at a variable gain amplifier based on the first variable gain control signal and the alternating current signal, wherein the transducer amplifier generates the first trapping signal based on the first variable gain voltage signal.

In Example 13, the subject matter of Example 12 includes, providing a first control signal sweep through a first sequence of frequencies from the controller to the variable gain amplifier; receiving a first plurality of peak voltages from the peak detector at the controller; identifying the first resonance frequency at the controller based on the first plurality of peak voltages; and generating the first variable gain control signal at the controller based on the first resonance frequency.

In Example 14, the subject matter of Example 13 includes, providing a second control signal sweep through a second sequence of frequencies from the controller to the variable gain amplifier; receiving a second plurality of peak voltages from the peak detector at the controller; identifying a second resonance frequency at the controller based on the second plurality of peak voltages, the second resonance frequency different from the first resonance frequency; generating a second variable gain control signal at the controller based on the second resonance frequency; generating a second variable gain voltage signal at the variable gain amplifier based on the second variable gain control signal; and generating a second trapping signal at the second resonance frequency at the transducer amplifier based on the second variable gain voltage signal.

In Example 15, the subject matter of Examples 12-14 includes, wherein the peak detector includes a current boosting amplifier to reduce an absolute error of the peak detector.

In Example 16, the subject matter of Examples 12-15 includes, generating a current signal at a current meter based on a power supply current provided to the transducer amplifier, wherein the controller generating the first variable gain control signal is further based on the current signal.

In Example 17, the subject matter of Examples 11-16 includes, wherein the transducer amplifier includes a plurality of sub-amplifiers disposed in parallel.

In Example 18, the subject matter of Examples 11-17 includes, transmitting the first acoustic standing wave from the piezoelectric transducer disposed on a coupling layer; and reflecting the first acoustic standing wave from a reflecting layer back to the piezoelectric transducer.

In Example 19, the subject matter of Examples 11-18 includes, wherein a sample pump passes the particle sample through the first acoustic standing wave.

In Example 20, the subject matter of Example 19 includes, retaining the first particle type within a first reservoir after separation by the piezoelectric transducer; and retaining the second particle type within a second reservoir after separation by the piezoelectric transducer.

Example 21 is at least one non-transitory machine-readable storage medium, comprising instructions that, responsive to being executed with processor circuitry of a computer-controlled device, cause the processor circuitry to: generate an alternating current signal at a signal generator; generate a first trapping signal at a transducer amplifier based on the alternating current signal; generate a first acoustic standing wave at a first resonance frequency at a piezoelectric transducer disposed on a microfluidic substrate based on the first trapping signal; and pass a particle sample through the first acoustic standing wave to separate a first particle type from a second particle type.

In Example 22, the subject matter of Example 21 includes, the instructions further causing the processor circuitry to: determine a peak voltage at a peak detector based on the first trapping signal; generate a first variable gain control signal at a controller based on the peak voltage; and generate a first variable gain voltage signal at a variable gain amplifier based on the first variable gain control signal and the alternating current signal, wherein the transducer amplifier generates the first trapping signal based on the first variable gain voltage signal.

In Example 23, the subject matter of Example 22 includes, the instructions further causing the processor circuitry to: provide a first control signal sweep through a first sequence of frequencies from the controller to the variable gain amplifier; receive a first plurality of peak voltages from the peak detector at the controller; identify the first resonance frequency at the controller based on the first plurality of peak voltages; and generate the first variable gain control signal at the controller based on the first resonance frequency.

In Example 24, the subject matter of Example 23 includes, the instructions further causing the processor circuitry to: provide a second control signal sweep through a second sequence of frequencies from the controller to the variable gain amplifier; receive a second plurality of peak voltages from the peak detector at the controller; identify a second resonance frequency at the controller based on the second plurality of peak voltages, the second resonance frequency different from the first resonance frequency; generate a second variable gain control signal at the controller based on the second resonance frequency; generate a second variable gain voltage signal at the variable gain amplifier based on the second variable gain control signal; and generate a second trapping signal at the second resonance frequency at the transducer amplifier based on the second variable gain voltage signal.

In Example 25, the subject matter of Examples 22-24 includes, wherein the peak detector includes a current boosting amplifier to reduce an absolute error of the peak detector.

In Example 26, the subject matter of Examples 22-25 includes, the instructions further causing the processor circuitry to generate a current signal at a current meter based on a power supply current provided to the transducer amplifier, wherein the controller generating the first variable gain control signal is further based on the current signal.

In Example 27, the subject matter of Examples 21-26 includes, wherein the transducer amplifier includes a plurality of sub-amplifiers disposed in parallel.

In Example 28, the subject matter of Examples 21-27 includes, the instructions further causing the processor circuitry to: transmit the first acoustic standing wave from the piezoelectric transducer disposed on a coupling layer; and reflect the first acoustic standing wave from a reflecting layer back to the piezoelectric transducer.

In Example 29, the subject matter of Examples 21-28 includes, the instructions further causing the processor circuitry to convey the sample through the first acoustic standing wave.

In Example 30, the subject matter of Example 29 includes, the instructions further causing the processor circuitry to: retain the first particle type within a first reservoir after separation by the piezoelectric transducer; and retain the second particle type within a second reservoir after separation by the piezoelectric transducer.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above detailed description includes references to the accompanying drawings, which form a part of the detailed description. The drawings show, by way of illustration, specific examples in which the invention may be practiced. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples, with each claim standing on its own as a separate example, and it is contemplated that such examples may be combined with each other in various combinations or permutations. The scope of the invention should be determined with reference to the appended claims, along with the full scope of equivalents to which such claims are entitled.

What is claimed is:

1. A system for acoustic trapping microchannel resonance detection and control, the system comprising:
a signal generator to generate an alternating current signal;
a transducer amplifier to generate a first trapping signal based on the alternating current signal; and
a piezoelectric transducer disposed on a microfluidic substrate to generate a first acoustic standing wave at a first resonance frequency based on the first trapping signal, the first acoustic standing wave to separate a first particle type from a second particle type.

2. The system of claim 1, further including:
a peak detector to determine a peak voltage based on the first trapping signal;
a controller to generate a first variable gain control signal based on the peak voltage; and
a variable gain amplifier to generate a first variable gain voltage signal based on the first variable gain control signal and the alternating current signal, wherein the transducer amplifier generates the first trapping signal based on the first variable gain voltage signal.

3. The system of claim 2, wherein the controller is further configured to:
provide a first control signal sweep through a first sequence of frequencies to the variable gain amplifier;
receive a first plurality of peak voltages from the peak detector;
identify the first resonance frequency based on the first plurality of peak voltages; and
generate the first variable gain control signal based on the first resonance frequency.

4. The system of claim 3, wherein the controller is further configured to:
provide a second control signal sweep through a second sequence of frequencies to the variable gain amplifier;
receive a second plurality of peak voltages from the peak detector;
identify a second resonance frequency based on the second plurality of peak voltages, the second resonance frequency different from the first resonance frequency;
generate a second variable gain control signal based on the second resonance frequency;
cause the variable gain amplifier to generate a second variable gain voltage signal based on the second variable gain control signal; and
cause the transducer amplifier to generate a second trapping signal at the second resonance frequency based on the second variable gain voltage signal.

5. The system of claim 2, wherein the peak detector includes a current boosting amplifier to reduce an absolute error of the peak detector.

6. The system of claim 2, further including a current meter to generate a current signal based on a power supply current provided to the transducer amplifier, wherein the controller generating the first variable gain control signal is further based on the current signal.

7. The system of claim 1, wherein the transducer amplifier includes a plurality of sub-amplifiers disposed in parallel.

8. The system of claim 1, further including:
a coupling layer, the piezoelectric transducer disposed on the coupling layer; and
a reflecting layer disposed opposite from the coupling layer, the reflecting layer to reflect the first acoustic standing wave back to the piezoelectric transducer.

9. The system of claim 1, further including a sample pump to convey a particle sample through the first acoustic standing wave, the particle sample including the first particle type and the second particle type.

10. The system of claim 9, further including:
a first reservoir to retain the first particle type after separation by the piezoelectric transducer; and
a second reservoir to retain the second particle type after separation by the piezoelectric transducer.

11. A method for acoustic trapping microchannel resonance detection and control, the method comprising:
generating an alternating current signal at a signal generator;
generating a first trapping signal at a transducer amplifier based on the alternating current signal;
generating a first acoustic standing wave at a first resonance frequency at a piezoelectric transducer disposed on a microfluidic substrate based on the first trapping signal; and
passing a particle sample through the first acoustic standing wave to separate a first particle type from a second particle type.

12. The method of claim 11, further including:
determining a peak voltage at a peak detector based on the first trapping signal;
generating a first variable gain control signal at a controller based on the peak voltage; and
generating a first variable gain voltage signal at a variable gain amplifier based on the first variable gain control signal and the alternating current signal, wherein the transducer amplifier generates the first trapping signal based on the first variable gain voltage signal.

13. The method of claim 12, further including:
providing a first control signal sweep through a first sequence of frequencies from the controller to the variable gain amplifier;
receiving a first plurality of peak voltages from the peak detector at the controller;
identifying the first resonance frequency at the controller based on the first plurality of peak voltages; and
generating the first variable gain control signal at the controller based on the first resonance frequency.

14. The method of claim 13, further including:
providing a second control signal sweep through a second sequence of frequencies from the controller to the variable gain amplifier;
receiving a second plurality of peak voltages from the peak detector at the controller;
identifying a second resonance frequency at the controller based on the second plurality of peak voltages, the second resonance frequency different from the first resonance frequency;
generating a second variable gain control signal at the controller based on the second resonance frequency;
generating a second variable gain voltage signal at the variable gain amplifier based on the second variable gain control signal; and
generating a second trapping signal at the second resonance frequency at the transducer amplifier based on the second variable gain voltage signal.

15. The method of claim 12, wherein the peak detector includes a current boosting amplifier to reduce an absolute error of the peak detector.

16. The method of claim 12, further including generating a current signal at a current meter based on a power supply current provided to the transducer amplifier, wherein the controller generating the first variable gain control signal is further based on the current signal.

17. The method of claim 11, wherein the transducer amplifier includes a plurality of sub-amplifiers disposed in parallel.

18. The method of claim 11, further including:
transmitting the first acoustic standing wave from the piezoelectric transducer disposed on a coupling layer; and
reflecting the first acoustic standing wave from a reflecting layer back to the piezoelectric transducer.

19. The method of claim 11, wherein a sample pump passes the particle sample through the first acoustic standing wave.

20. The method of claim 19, further including:
retaining the first particle type within a first reservoir after separation by the piezoelectric transducer; and
retaining the second particle type within a second reservoir after separation by the piezoelectric transducer.

21. At least one non-transitory machine-readable storage medium, comprising instructions that, responsive to being executed with processor circuitry of a computer-controlled device, cause the processor circuitry to:
generate an alternating current signal at a signal generator;
generate a first trapping signal at a transducer amplifier based on the alternating current signal;
generate a first acoustic standing wave at a first resonance frequency at a piezoelectric transducer disposed on a microfluidic substrate based on the first trapping signal; and
pass a particle sample through the first acoustic standing wave to separate a first particle type from a second particle type.

22. The at least one non-transitory machine-readable storage medium of claim 21, the instructions further causing the processor circuitry to:
determine a peak voltage at a peak detector based on the first trapping signal;
generate a first variable gain control signal at a controller based on the peak voltage; and
generate a first variable gain voltage signal at a variable gain amplifier based on the first variable gain control signal and the alternating current signal, wherein the transducer amplifier generates the first trapping signal based on the first variable gain voltage signal.

23. The at least one non-transitory machine-readable storage medium of claim 22, the instructions further causing the processor circuitry to:
provide a first control signal sweep through a first sequence of frequencies from the controller to the variable gain amplifier;
receive a first plurality of peak voltages from the peak detector at the controller;
identify the first resonance frequency at the controller based on the first plurality of peak voltages; and
generate the first variable gain control signal at the controller based on the first resonance frequency.

24. The at least one non-transitory machine-readable storage medium of claim 23, the instructions further causing the processor circuitry to:
provide a second control signal sweep through a second sequence of frequencies from the controller to the variable gain amplifier;
receive a second plurality of peak voltages from the peak detector at the controller;
identify a second resonance frequency at the controller based on the second plurality of peak voltages, the second resonance frequency different from the first resonance frequency;
generate a second variable gain control signal at the controller based on the second resonance frequency;
generate a second variable gain voltage signal at the variable gain amplifier based on the second variable gain control signal; and
generate a second trapping signal at the second resonance frequency at the transducer amplifier based on the second variable gain voltage signal.

25. The at least one non-transitory machine-readable storage medium of claim 21, the instructions further causing the processor circuitry to:
transmit the first acoustic standing wave from the piezoelectric transducer disposed on a coupling layer; and
reflect the first acoustic standing wave from a reflecting layer back to the piezoelectric transducer.
